(19) United States
(12) Patent Application Publication
(10) Pub. No.: US 2017/0154080 A1
(43) Pub. Date: Jun. 1, 2017

(54) PHASING OF MULTI-OUTPUT QUERY OPERATORS

(71) Applicant: Microsoft Technology Licensing, LLC, Redmond, WA (US)

(72) Inventor: Bart De Smet, Bellevue, WA (US)

(73) Assignee: Microsoft Technology Licensing, LLC, Redmond, WA (US)

(21) Appl. No.: 14/955,446

(22) Filed: Dec. 1, 2015

(51) Int. Cl. G06F 17/30; G06N 99/00

(52) U.S. Cl. CPC G06F 17/30516; G06F 17/30554; G06N 99/005

(57) ABSTRACT

Methods and devices are provided for analyzing a multi-output query. A data stream associated with a direct input and/or an indirect input related to a multi-output query is phased into a plurality of connectable resources. A plurality of nodes is identified within the plurality of connectable resources, and the plurality of nodes is processed to produce a data output. Additionally, a user interface is provided for building at least one multi-output query. A multi-output query input is received, at least one data stream is generated in response to the multi-output query, and nodes are identified that define data sub-streams within the at least one data stream. The nodes are processed to produce a data output responsive to the multi-output query, and a data sub-stream responsive to the at least one multi-output query is displayed through the graphical user interface.

### BACKGROUND

Data is generally retrieved from a database using queries composed of expressions that are written in a language that declaratively specifies what is to be retrieved. Such expressions are typically processed by a query processor, which is used to determine the query's execution plan, that is, the sequence of steps that will be taken to retrieve the requested data. Within this data retrieval framework, query operators may be utilized to map to lower-level language constructs and/or expression trees, making the process of data retrieval more efficient.

Expression trees represent code in a tree-like data structure composed of nodes, where each node within the tree-like data structure is an expression—for example, a method call or a binary operation such as x<y. Expression trees are useful in compiling and running code represented by the tree structure. This enables dynamic modification of executable code, the execution of queries in various databases, and the creation of dynamic queries. In general these methods operate on sequences, where a sequence is an object whose type implements the IEnumerable<T> interface (for persistent data) or the IObservable<T> interface (for streaming data). The standard query operators provide query capabilities including filtering, projection, aggregation, and sorting, among others, and provide a means for describing single-output, multi-input computations over sequences of data.

Certain queries, such as Language-Integrated Querys (LINQ), not only provide a way of retrieving data, but also provide a powerful tool for transforming data. By using such queries, a source sequence may be utilized as input and processed in various ways to create a new output sequence. Such queries allow for performing functions such as merging multiple input sequences into a single output sequence that has a new name; creating output sequences whose elements consist of only one or several properties of each element in the source sequence; creating output sequences whose elements consist of the results of operations performed on the source data; creating output sequences in a different format, and creating output sequences that contain elements from more than one input sequence. Such operators are typically mapped onto expression trees.

Data processing jobs may consist of one or more graphs that describe the flow of data through various operators. In particular, the use of directed acyclic graphs is popular amongst various data processing platforms, including extract-transform-load (ETL) data warehouse systems, which are systems that employ a process in database usage and especially in a data warehouse that: extract data from homogenous or heterogeneous data sources, transform the data for storing it in proper format or structure for querying and analysis purpose, and load it into the final target, e.g. a database, or more specifically, operational data store, data mart, or data warehouse. ETL systems commonly integrate data from multiple applications (systems), typically developed and supported by different vendors or hosted on separate computer hardware.

One aspect that can differ significantly between the two approaches described above (i.e. expression tree representation of query operators vs. graphical representation-based data flow through various query operators) is the phasing of lifecycle events for a computation. As used herein, “phasing” refers to the sequencing of various data transformation steps needed to split a sequence into sub-sequences, carry out transformations on each of those sub-sequences, and optionally, perform a data transformation to merge the resulting sub-sequences together. In this case, sequencing refers to an execution plan of discrete consecutive steps that are needed to perform the computation expressed in an expression tree. Phasing lifecycle events according to certain aspects disclosed herein produces a transformation of a single data stream containing data responsive to a query and graphically separates the data responsive to that query into sub-streams comprised of relevant or potentially relevant query responses, with each sub-stream being defined by a node. These nodes and their corresponding data sub-streams may be accessed and provided to a computing device by direct or passive user input relating to data contained within the sub-stream defined by the node.

In particular, a single-output expression-based approach allows lifecycle management operations to be exposed on the object created by the expression tree, for example to kick off the data processing, to pause/resume it, or to stop it. In contrast to a single-output query, a multi-output query produces multiple results from a single query, where each individual output is comprised of data associated with one or more of the sub-streams. Here, none of the objects representing those sub-streams can be used to trigger the entire data processing job, which requires a more elaborate lifecycle management solution, as discussed above with regard to phasing.

It is desirable to provide techniques to deal with phasing of multi-output query operators, whilst retaining the benefits of a compositional approach to designing query operators. It is with respect to this general technical environment that aspects of the present technology disclosed herein have been contemplated.

### SUMMARY

This summary is provided to introduce a selection of concepts in a simplified form that are further described in the Detailed Description section. This summary is not intended to identify key features or essential features of the claimed subject matter, nor is it intended to be used as an aid in determining the scope of the claimed subject matter.

Non-limiting examples of the present disclosure describe techniques for phasing multi-output query operators into sub-streams defined by a series of nodes responsive to the multi-output query operators. One or more of these sub-streams may be output by a computing device, e.g., in response to direct input from a user related to one or more nodes or input learned by the computing device by way of dynamic training. Such training may involve past user input or indirect input which allows the computing device and the methods employed by the computing device to determine which nodes related to the multi-output queries (and their corresponding data stream[s]) may be of interest to the user(s) that the computing device learned from. The computing device may be utilized by one or more users and may make an initial determination regarding the current user so that appropriate training data and learned behavior patterns can be applied to each user. The initial determination regarding the current user may be made by analyzing a unique passcode input into the device that relates to one or more users of the device, voice identification of a user of the device, or other similar means.

In other non-limiting examples of the present disclosure, a user interface is provided for graphically phasing at least one multi-output query into a series of sub-streams defined by one or more nodes associated with a set of connectable resources, and a subset of data representative of one or more sub-streams responsive to at least one multi-output query may be displayed through a graphical user interface.

### BRIEF DESCRIPTION OF THE DRAWINGS

Non-limiting and non-exhaustive examples are described with reference to the following figures. As a note, the same number represents the same element or same type of element in all drawings.

FIG. 1A illustrates a mobile computing device for executing one or more aspects of the present disclosure.

FIG. 1B is a simplified block diagram of a mobile computing device with which aspects of the present invention may be practiced.

FIG. 2 is an exemplary method for phasing multi-query operators.

FIG. 3 is a simplified diagram of a distributed computing system in which aspects of the current invention may be practiced.

FIG. 4 illustrates phasing of subscription and data flow using connectable resources according to aspects of the current invention.

FIG. 5 is a simplified block diagram of a distributed computing system in which aspects of the present invention may be practiced.

FIG. 6 is a block diagram illustrating physical components (e.g. hardware) of a computing device 600 with which aspects of the disclosure may be practiced.

### DETAILED DESCRIPTION

Various aspects are described more fully below with reference to the accompanying drawings, which form a part hereof, and which show specific exemplary aspects. However, examples may be implemented in many different forms and should not be construed as limited to the examples set forth herein. Accordingly, examples may take the form of a hardware implementation, or an entirely software implementation, or an implementation combining software and hardware aspects. The following detailed description is, therefore, not to be taken in a limiting sense.

Non-limiting examples of the present disclosure describe techniques for phasing multi-output query operators connected by data paths within a data flow graph (e.g. declared by means of an expression tree). In aspects described herein, the notion of data flow is based on the concept a network of processes connected by data paths. In a purely functional data flow model the processes act solely on the data arriving on their input data paths and the data that is sent on the output data paths is no more than a function of the input data. Such data flow graphs provide a means for representing lambda expressions that represent data transformations, and in effect form a machine code for arbitrary combinators, which are simply lambda expressions with no free variables and fully bound to input and output sequences.

According to other non-limiting examples of the present disclosure, multi-output queries are received by a computing device, which generates a data stream responsive to the multi-output query and identifies a plurality of nodes within the generated data stream. Each of the plurality of nodes relates to a data sub-stream within the data stream and the computing device processes at least one of the plurality of nodes to produce a data output responsive to the multi-output query.

In other non-limiting examples of the present disclosure, a user interface is provided for building at least one multi-output query. An input is received to provide a multi-output query. A main data stream is phased into a plurality of data sub-streams by processing a plurality of nodes which individually relate to subsets of data within the main data stream. At least one of the plurality of nodes is processed to produce a data output responsive to the at least one multi-output query, and the subset of data responsive to the at least one multi-output query is displayed through the graphical user interface.

According to aspects at least one multi-output query comprises a user inputting into a local computing device a request to subscribe to a data sub-stream of a data stream.

In an additional aspect at least one multi-output query is automatically received by a computing device based on user preferences learned from user interactions with a local computing device by way of dynamic training. Such training may involve past user input or indirect input which allows the computing device and the methods employed by the computing device to determine which nodes related to the multi-output queries (and their corresponding data stream[s]) may be of interest to the user(s) the computing device has learned from. The computing device may be utilized by one or more users and may make an initial determination regarding a current user so that appropriate training data and learned behavior patterns may be applied to each user. The initial determination of which user is currently using the computing device may be made by analyzing a unique passcode input into the device that relates to one or more user of the device, voice identification of a user of the device, or other similar means.

In certain other aspects the data stream is dynamically extended to produce a data output responsive to an additional multi-output query.

In another aspect, after receiving an initial multi-output query and processing a first data sub-stream corresponding to a first node within a data stream, at least a second data sub-stream corresponding to a second node within the data stream is processed to produce a data output responsive to processing a request to subscribe to the second data sub-stream of the main data stream.

In yet another aspect, a plurality of multi-output queries are received from a plurality of users and a computing device automatically determines which of the plurality of users is accessing the computing device and a data output is generated corresponding to each user's multi-output query.

In additional aspects, a plurality of multi-output queries are received by a computing device and the computing device associates each of the plurality of multi-output queries with one or more of a plurality of users by analyzing a plurality of personalized passcodes input into the computing device.

According to some aspects (e.g., persistent data), data output responsive to a plurality of multi-output queries is stored on at least one server device. Alternatively, at least one sub-stream of a streaming data output is processed after receiving a query for the data output.

A number of technical advantages are achieved based on the present disclosure including but not limited to: reducing the amount of stored data when processing multiple data retrieval operations, avoiding data loss associated with analyzing two or more real-time data streams (e.g., stock market info for two or more stocks, trending social media topics, popular hashtags, etc.), avoiding buffering delays generally associated with analyzing two or more queries, the ability to split/process a large amount of data amongst many different servers, providing the ability to share sub-computations and allow new incoming queries (as persistent or streaming data) to “tag onto” the already existing sub-computation, providing a means for separating the data flow design from operational semantics, decoupling the activation sequence from data flow design, the ability to obtain activation procedures by combining graph traversal algorithms and the algebraic laws of connectable resources, and providing cooperative traversal of data flow.

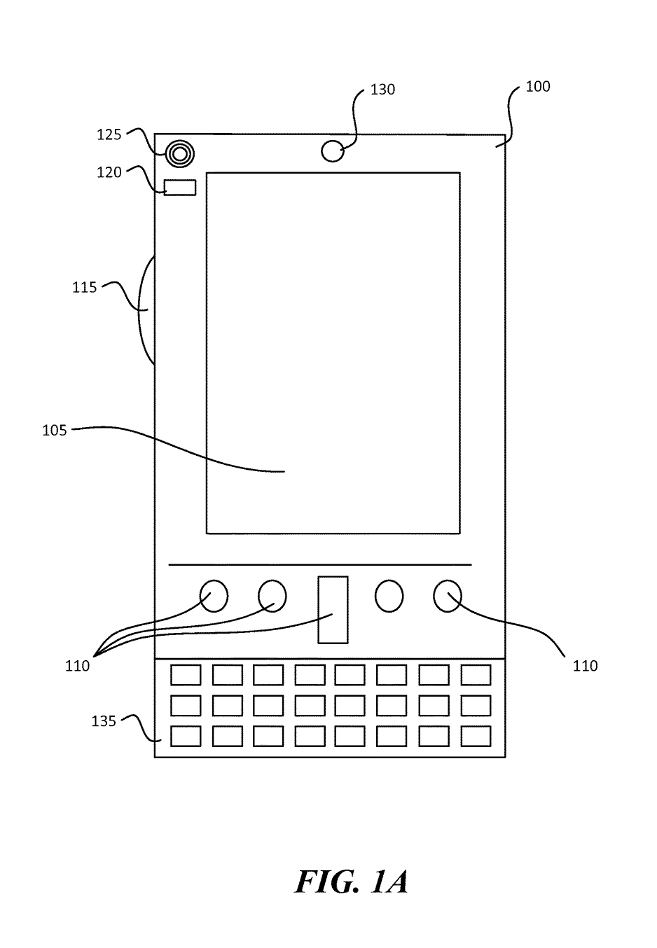

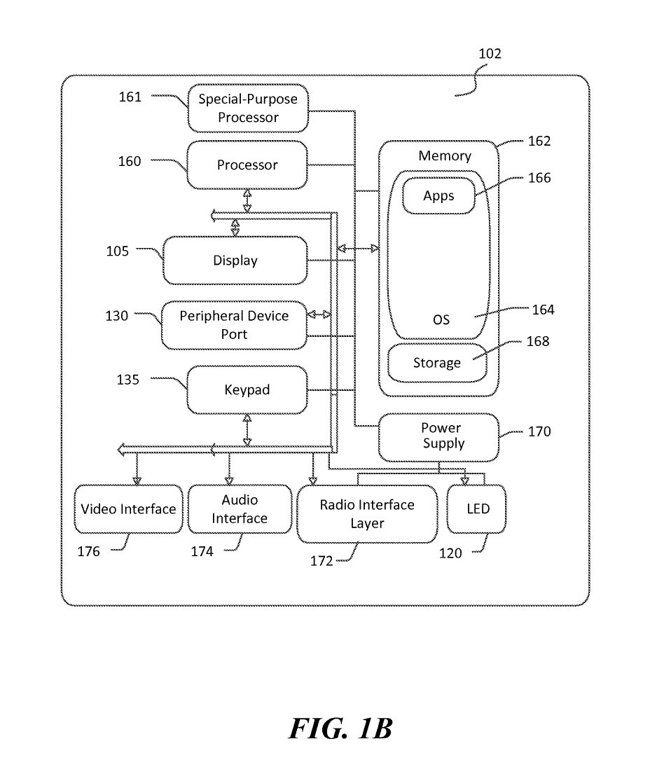

FIG. 1A and FIG. 1B illustrate computing device 100, for example, a mobile telephone, a smart phone, a tablet personal computer, a laptop computer, and the like, with which embodiments of the disclosure may be practiced. With reference to FIG. 1A, an exemplary mobile computing device 100 for implementing the embodiments is illustrated. In a basic configuration, the mobile computing device 100 is a handheld computer having both input elements and output elements. The mobile computing device 100 typically includes a display 105 and one or more input buttons 110 that allow the user to enter information into the computing device 100. The display 105 of the mobile computing device 100 may also function as an input device (e.g., a touch screen display). If included, an optional side input element 115 allows further user input. The side input element 115 may be a rotary switch, a button, or any other type of manual input element. In alternative embodiments, mobile computing device 100 may incorporate more or less input elements. For example, the display 105 may not be a touch screen in some embodiments. In yet another alternative embodiment, the mobile computing device 100 is a portable phone system, such as a cellular phone. The mobile computing device 100 may also include an optional keypad 135. Optional keypad 135 may be a physical keypad or a “soft” keypad generated on the touch screen display. In various embodiments, the output elements include the display 105 for showing a graphical user interface (GUI), a visual indicator 120 (e.g., a light emitting diode) and/or an audio transducer 125 (e.g., a speaker). In some embodiments, the mobile computing device 100 incorporates a vibration transducer for providing the user with tactile feedback. In yet another embodiments, the mobile computing device 100 incorporates input and/or output ports, such as an audio input (e.g., a microphone jack), an audio output (e.g., a headphone jack), and a video output (e.g., a HDMI port) for sending signals to or receiving signals from an external device. In embodiments, the data output for the processed nodes may be displayed on the display 105.

FIG. 1B is a block diagram illustrating the architecture of one embodiment of a mobile computing device. That is, the mobile computing device 100 can incorporate a system (i.e., an architecture) 102 to implement some embodiments. In one embodiment the system 102 is implemented as a “smart phone” capable of running one or more applications (e.g., browser, e-mail, calendaring, contact managers, messaging clients, games, and media clients/players). In some embodiments, the system 102 is integrated as a computing device, such as an integrated personal digital assistant (PDA) and a wireless phone).

One or more application programs 166 may be loaded into the memory 162 and run on or in association with the operating system 164. Examples of the application programs include phone dialer programs, e-mail programs, personal information management (PIM) programs, word processing programs, spreadsheet programs, Internet browser programs, messaging programs, diagramming applications, and so forth. The system 102 also includes a non-volatile storage area 168 within the memory 162. The non-volatile storage area 168 may be used to store persistent information that should not be lost if the system 102 is powered down. The application programs 166 may use and store information in the non-volatile storage area 168, such as e-mail or other messages used by an e-mail application, and the like. A synchronization application (not shown) also resides on the system 102 and is programmed to interact with a corresponding synchronization application resident on a host computer to keep the information stored in the non-volatile storage area 168 synchronized with corresponding information stored in the host computer. As should be appreciated, other applications may be loaded into the memory 162 and run on the mobile computing device 100, including steps and methods of receiving a multi-output query, phasing a data stream into a plurality of connectible resources, identifying a plurality of nodes within a plurality of connectable resources which are simply nodes (operations) connected by wires (variables) within a data flow graph (e.g., an expression tree), processing at least one of a plurality of nodes to provide a data output responsive to a multi-output query, storing a data output on at least one server, receiving a query for stored data output, and displaying at least one subset of a stored data output.

The system 102 has a power supply 170, which may be implemented as one or more batteries. The power supply 170 might further include an external power source, such as an AC adapter or a powered docking cradle that supplements or recharges the batteries.

The system 102 may also include a radio 172 that performs the functions of transmitting and receiving radio frequency communications. The radio 172 facilitates wireless connectivity between the system 102 and the “outside world,” via a communications carrier or service provider. Transmissions to and from the radio 172 are conducted under control of the operating system 164. In other words, communications received by the radio 172 may be disseminated to the application programs 166 via the operating system 164, and vice versa. The radio 172 allows the system 102 to communicate with other computing devices such as over a network. The radio 172 is one example of communication media. Communication media may typically be embodied by computer readable instructions, data structures, program modules, or other data in a modulated data signal, such as a carrier wave or other transport mechanism, and includes any information deliver media. The term “modulated data signal” means a signal that has one or more of its characteristics set or changed in such a manner as to encode information in the signal. By way of example, not limitation, communication media includes wired media such as a wired network or direct-wired connection, and wireless media such as acoustic, RF infrared and other wireless media. The term computer readable media is used herein includes both storage media and communication media.

This embodiment of the system 102 provides notifications using the visual indicator 120 that can be used to provide visual notifications and/or an audio interface 174 producing audible notifications via the audio transducer 125. In the illustrated embodiment, the visual indicator 120 is a light emitting diode (LED) and the audio transducer 125 is a speaker. These devices may be directly coupled to the power supply 170 so that when activated, they remain on for a duration dictated by the notification mechanism even though the processor 160 and other components might shut down for conserving battery power. The LED may be programmed to remain on indefinitely until the user takes action to indicate the powered-on status of the device. The audio interface 174 is used to provide audible signals to and receive audible signals from the user. For example, in addition to being coupled to the audio transducer 125, the audio interface 174 may also be coupled to a microphone to receive audible input, such as to facilitate a telephone conversation. In accordance with embodiments of the present invention, the microphone may also serve as an audio sensor to facilitate control of notifications, as will be described below. The system 102 may further include a video interface 176 that enables an operation of an on-board camera 130 to record still images, video stream, and the like.

A mobile computing device 100 implementing the system 102 may have additional features or functionality. For example, the mobile computing device 100 may also include additional data storage devices (removable and/or non-removable) such as, magnetic disks, optical disks, or tape. Such additional storage is illustrated in FIG. 1B by the non-volatile storage area 168. Computer storage media may include volatile and nonvolatile, removable and non-removable media implemented in any method or technology for storage of information, such as computer readable instructions, data structures, program modules, or other data.

Data/information generated or captured by the mobile computing device 100 and stored via the system 102 may be stored locally on the mobile computing device 100, as described above, or the data may be stored on any number of storage media that may be accessed by the device via the radio 172 or via a wired connection between the mobile computing device 100 and a separate computing device associated with the mobile computing device 100, for example, a server computer in a distributed computing network, such as the Internet. As should be appreciated such data/information may be accessed via the mobile computing device 100 via the radio 172 or via a distributed computing network. Similarly, such data/information may be readily transferred between computing devices for storage and use according to well-known data/information transfer and storage means, including electronic mail and collaborative data/information sharing systems.

One of skill in the art will appreciate that the scale of systems such as system 100 may vary and may include more or fewer components than those described in FIG. 1. In some examples, interfacing between components of the system 100 may occur remotely, for example where components of system 100 may be spread across one or more devices of a distributed network. In examples, one or more data stores/storages or other memory are associated with system 100. For example, a component of system 100 may have one or more data storages/memories/stores associated therewith. Data associated with a component of system 100 may be stored thereon as well as processing operations/instructions executed by a component of system 100.

With the above concepts established the following provides a description of compilation target for data flow designers.

Connectable resources provide for a desirable compilation target in data flow designs, separating the actual data flow from the act of wiring up operators in a graph. It is not until a connect operation is carried out—typically at runtime rather than design time—that data starts flowing over the connections that have been established.

The generalization of connectable resources (independent of their data flow nature, e.g. push or pull, synchronous or asynchronous, etc.) provides for a means to separate the data flow design from the operational semantics. That is, according to aspects disclosed herein, the activation sequence is decoupled from the data flow design (generally described as a data flow graph, often acyclic in nature). Additionally, the activation procedures can be obtained by combining graph traversal algorithms and the algebraic laws of connectable resources.

Aspects of the disclosure provide for traversal of a data flow graph from sources (inputs) to sinks (outputs) (i.e., nodes with no incoming edges), whereby parallel composition of connections can be built. For each node where multiple connectable sources come together, combinators like “Sequence” (connect one resource after another), “Parallel” (connect multiple resources at the same time), “Timeout” (time out connection attempts after a specified duration), “RefCount” (connect only when at least one consumer is present), etc., can be used to combine the connections of smaller data flows so as to retain one connectable handle for the entire data flow. In aspects, a policy for combining connection and disconnection activities (i.e. passive or direct subscribe and unsubscribe input) for various nodes defining the data sub-streams can be kept separate from the data flow design itself.

The following provides a non-limiting description of cooperative data flow graph traversal utilizing the visitor pattern. As will be well understood by those of skill in the art, visitors enable dispatching operations to nodes in a graph by following a specified traversal pattern. This further extension of the abstraction includes the addition of a visitor pattern, such as, by way of example:

interface IConnectable
{

void Accept(IConnectableVisitor visitor);

IDisposable Connect( );

}
interface IConnectableVisitor
{

void Visit(IConnectable connectable);

}
Using this pattern, traversal of a data flow graph cooperative can be made. That is, operators associated with multiple connectable resources can dispatch traversal operations in a well-defined order, e.g. to carry out various operations such as establishing or disposing of connections. For the parts of data flow that do not cooperate in “connectable phasing,” a visitor may need to trivially dispatch to the inputs of such an opaque portion of the data flow. As described herein, these visitors are components configured to visit, or in other words traverse, and object graph, for example recursively and while carrying out cycle detection. For each object visited, the function structure may be construed to enable further action to be taken.

One advantage of utilizing a cooperative traversal mechanism according to aspects described herein is that exemplary environments can be built without any knowledge of the operators' inner workings. For example, data flow designers that need to produce an activation scheme could do so without understanding which operator parameters act as inputs or as outputs. To traverse operators hunting for inputs in a recursive manner, one could dispatch a visitor to which operators “react” during the call to “Accept” by means of traversing their inputs. According to aspects, various cycle detection logics may be provided by the environment, but traversal order does not need to be understood by the environment.

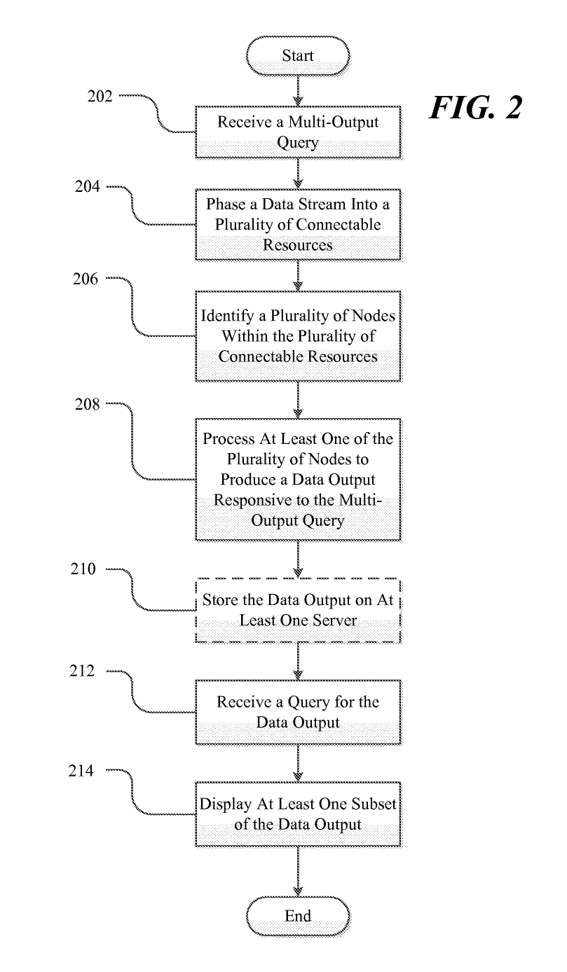

In view of the exemplary systems described supra, methodologies that may be implemented in accordance with the disclosed subject matter will be better appreciated with reference to the flowchart of FIG. 2. While for purposes of simplicity of explanation, the methodologies are shown and described as a series of blocks, some blocks may occur in different orders and/or concurrently with other blocks from what is depicted and described herein. Moreover, not all illustrated blocks may be required to implement the methods described hereinafter.

Referring to FIG. 2, an illustration of a flowchart representing an embodiment of a method 200 for phasing multi-output queries is provided. Flow begins at operation 202 where computing device 100 receives a multi-output query.

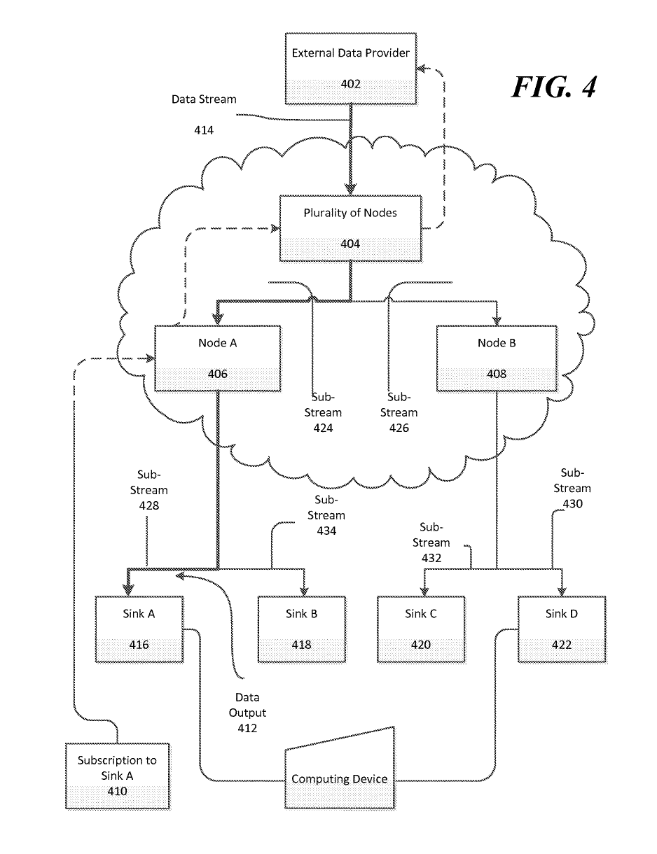

As an example, a user may input (passively or directly), and computing device 100 may receive, a query related to one or more stocks traded on major stock exchanges. In aspects, this request may be processed into a data flow graph composed of connectable resources comprising compiled data related to all major stock exchanges. In such a data flow graph the compiled data may be represented by data stream 414 in FIG. 4. Such a request, by way of this non-limiting example, may include interest on the user's behalf regarding U.S. and/or international stock exchanges correlating to a plurality of nodes 404. In such an example, the user's request may be directed towards stocks traded on NASDAQ, which by way of example may correspond to Node A 406, or more specifically directed towards Microsoft (MSFT) stock, which by way of example may correspond to data output 412 received by Sink A 416 and Facebook (FB) (Sink B 418), as well as stocks such as Alibaba (BABA) (Sink C 420) traded on the NYSE, which by way of example may correspond to Node B 408.

In another example, a user may input, and the computing device 100 may receive, a query related to a specific theme or content for one or more social media or microblogging services. Labels or metadata tags may be utilized in such examples to make it easier for users to find messages associated with the query. For example, on a photo-sharing service, e.g., Instagram, the hashtag #bluesky allows users to find images that have been tagged as containing the sky, and #cannes2014 is a popular tag for images from the 2014 Cannes Film Festival. Such queries can be used to collect public opinion on events and ideas at the local, corporate, or worldwide level. For example, searching the social media service Twitter for #worldcup2014 returns many tweets from individuals around the globe about the 2014 Federation Internationale de Football Association (FIFA) World Cup. Upon receiving the multi-output query, flow continues to operation 204 wherein data stream 414 as shown in FIG. 4 is phased into a plurality of connectable resources.

According to yet another example, a user A may submit a query to filter stocks based on company I and compute their daily moving average, and a user B may submit a query to filter stocks based on company I when the stock price exceeds a certain value N. In this example, data stream 414 is produced in response to user A's query, and Node A 406 may relate to company I and sub-stream 428 may relate to company I's daily moving average. When user B submits the query related to filtering stocks based on company I when the stock price exceeds a certain value N, that query may reuse the filtering logic established by User A's query, and “fork” the graph from that node, Node A 406, (producing the sub-stream 434 of stocks for company I) to tag on a filter for a stock price exceeding value N. In this way, sub-computations may be shared, allowing new incoming queries (over persistent or streaming data) to “tag onto” the already existing sub-computation.

Multi-input queries may be split into a plurality of data streams depending on any number of variables. For example, on Twitter, when a hashtag becomes extremely popular, it will appear in the “Trending Topics” area of a user's homepage. The trending topics can be organized by geographic area or by all of Twitter. Thus, in some aspects, the data stream may be split based on a user's geographic area, by whether the hashtag was identified in “Trending Topics” or not, and the like.

For example, as illustrated in FIG. 4, a data stream 414 responsive to a query to a hashtag relating to a trending topic (e.g. #KatyPerry) may be split into multiple sub-streams by a plurality of nodes 404 by geographic location (e.g. Katy Perry's popularity in the greater Seattle area [e.g., Node A 406] vs. her popularity in New England [e.g., Node B 408]). Nodes A and B may be further spilt into additional sub-streams according to more specific categories such as, by way of example, neighborhoods in Seattle (e.g. Green Lake—Sink A 416, Capitol Hill—Sink B 418), and cities in New England (e.g. Boston—Sink C 420, Concord—Sink D 422).

In aspects, although a user may input an initial query related to Katy Perry's popularity in Green Lake and a corresponding initial data output 412 may be provided to the user corresponding to Sink A 416, all data relating to hashtag #KatyPerry within data stream 414 may be dynamically accessed by way of processing individual nodes related to a subscription to subscription 410 to Sink A 416 such that, upon further direct or indirect input from the user directed to Node B 408 and its corresponding sinks, the data output may be sent to the user without time and buffering delays associated with providing data output associated with additional queries according to previous methods whereby a new data stream 414 would need to be opened up for each successive query, whether the successive query is related to an initial query or not.

Flow continues to operation 206 where a computing device identifies a plurality of nodes 404 (FIG. 4) within the plurality of connectable resources corresponding to sub-streams of data within data stream 414. Using the example of the multi-output stock exchange query above, Node A 406 may represent NASDAQ and associated stocks such as MSFT and FB, and Node B 408 may represent the NYSE and associated stocks such as BABA. Other non-limiting examples of nodes may involve other entities, such as, Node A 406 (US stock exchange) and Node B 408 (Chinese or other international stock exchange(s)). In yet other non-limiting examples, the plurality of nodes 404 may correspond to subsets of data contained within data stream 414 corresponding to various social media sources (e.g., data streamed from Twitter, Instagram, Facebook, or other social media metrics) related to the popularity of entertainers such as Katy Perry [e.g., Node A 406] vs. Lady Gaga [e.g., Node B 408], and/or Taylor Swift [not shown, e.g., Node C].

According to some aspects, data stream 414 may be split into sub-streams defined by a plurality of nodes by a user's direct input. In an example, a user may input into the computing device, via a social media platform accessed on the computing device, hashtags such as #KatyPerry [e.g., Node A 406] vs #LadyGaga [e.g., Node B 408], and/or #TaylorSwift [e.g., Node C]. Such queries may be further split into additional nodes or subnodes (not shown) by including additional tagging designations, such as #KatyPerry # SuperBowl, #KatyPerry #LeftShark, #LadyGaga #VerizonCenter, #LadyGaga #Washington, #TaylorSwift #VMAs, and #TaylorSwift #Grammys.

According to additional aspects, data stream 414 may be split utilizing indirect input comprising adaptive learning by a computing device. For example, the device may be trained using a variety of data input by a user. Examples of such training data may include data received from a past user. Examples may also include data from corresponding stocks of interest or a user monitoring the state of economic affairs for one or more countries. For example, if a user frequently utilizes computing device 100 to access information related to Chinese markets, computing device 100 may automatically create a node related to Chinese markets. In such an example the automatically created node may be represented in FIG. 4 as node A 406.

In another aspect data stream 414 may be split utilizing a combination of direct input and indirect input as described above.

Continuing on, the flow proceeds to operation 208 where a computing device processes at least one of the plurality of nodes 404 and produces a first data output 412 responsive to the multi-output query, the first data output 412 corresponding to a first sub-stream of data from data stream 414 and is based at least in part on user input directed to accessing data associated with the partitioned plurality of nodes.

From operation 208 the flow continues to optional operation 210 (identified with dashed lines) where the data responsive to a multi-output query may be stored, e.g., on at least one server. Although storing data is not generally appropriate when processing streaming data (e.g., data stream 414), it may be desirable to do so when processing persistent output data according to aspects of this disclosure.

At operation 212, a second query for data output from data stream 414 corresponding to one or more previously un-accessed nodes is received, and at operation 214 at least a second data output corresponding to a second sub-stream of the data output from data stream 414 is displayed. In aspects, data output from the second sub-stream may be sent to the user without time and buffering delays associated with providing data output in response to additional queries according to previous methods whereby a new data stream 414 would need to be opened up for each successive query.

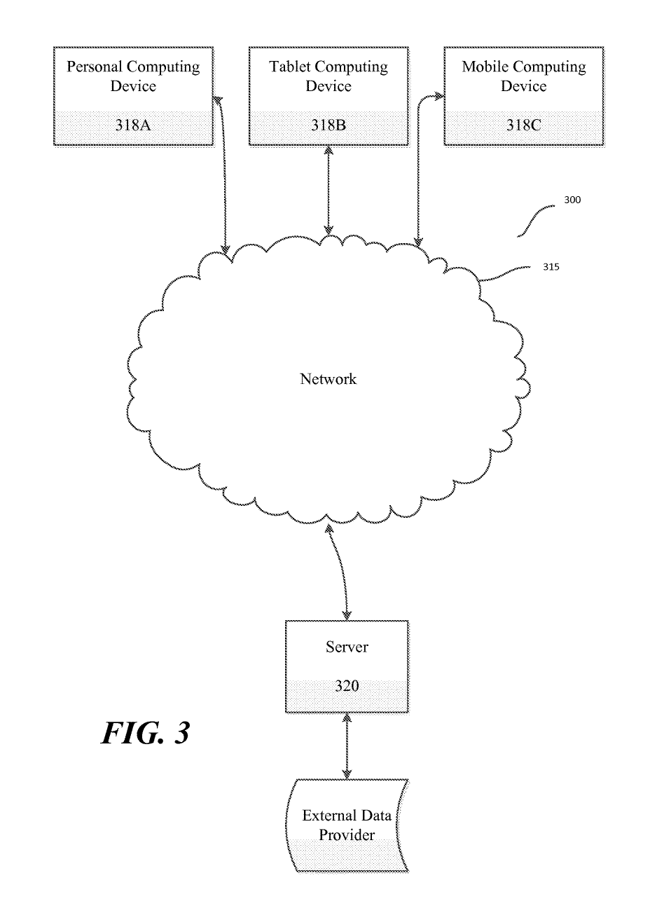

Turning to FIG. 3, one embodiment of the architecture of a system for phasing multi-query operators and executing the methods described herein to one or more client devices is provided. Content and/or data interacted with, requested, or edited in association with multi-query operators may be stored in different communication channels or other storage types. For example, data may be stored using a directory service, a web portal, a mailbox service, an instant messaging store, or a social networking site. The system for phasing multi-query operators and executing the methods described herein may use any of these types of systems or the like for enabling data utilization, as described herein. A computing device 318A, 318B, and/or 318C may provide a request to a cloud/network, which is then processed by a server 320 in communication with an external data provider 317. As one example, the server 317 may provide data stream 414 over the web to the computing device 318A, 318B, and or 318C through a network 315. By way of example, the client computing device 318 may be implemented as the computing device 102, and embodied in a personal computing device 318A, a tablet computing device 318B, and/or a mobile computing device 318C (e.g., a smart phone). Any of these embodiments of the client computing device 102 may obtain content from the external data provider 317. In various embodiments, the types of networks used for communication between the computing devices that makeup the present invention include, but are not limited to, an internet, an intranet, wide area networks (WAN), local area networks (LAN), and virtual private networks (VPN). In the present application, the networks include the enterprise network and the network through which the client computing device accesses the enterprise network. In another embodiment, the client network is a separate network accessing the enterprise network through externally available entry points, such as a gateway, a remote access protocol, or a public or private internet address.

Additionally, the logical operations may be implemented as algorithms in software, firmware, analog/digital circuitry, and/or any combination thereof, without deviating from the scope of the present disclosure. The software, firmware, or similar sequence of computer instructions may be encoded and stored upon a computer readable storage medium. The software, firmware, or similar sequence of computer instructions may also be encoded within a carrier-wave signal for transmission between computing devices.

Operating environment 300 typically includes at least some form of computer readable media. Computer readable media can be any available media that can be accessed by processor 160 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 300 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

As stated above, a number of program modules and data files may be stored in the system memory 162. While executing on processor 160, program modules (e.g., applications, Input/Output (I/O) management, and other utilities) may perform processes including, but not limited to, one or more of the stages of the operational methods described herein such as method 200 illustrated in FIGS. 200 and 400, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 1 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 102 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

FIG. 4 illustrates exemplary aspects of phasing multi-output queries. A user may subscribe to Sink A 410 corresponding to a subset of data within data stream 414 provided by one or more external data providers 402. External data provider(s) 402 provide data stream 414 comprising a set of data related to the user's subscription 410 to Sink A 416 which is further split into a plurality of nodes 404 comprised of sub-streams, e.g., 424, 426, 428, 430, 432 and 434 of data stream 414, and which may be further split into additional nodes 405 and 408 corresponding to additional sub-streams of data stream 414. Data corresponding to the plurality of nodes 404 is stored in a cloud or other computing environment and may be dynamically split and accessed by a user upon inputting a subscription to Sink A 410 into computing device 100 relating to a sub-stream of data accessible by way of stored data corresponding to the plurality of nodes 404.

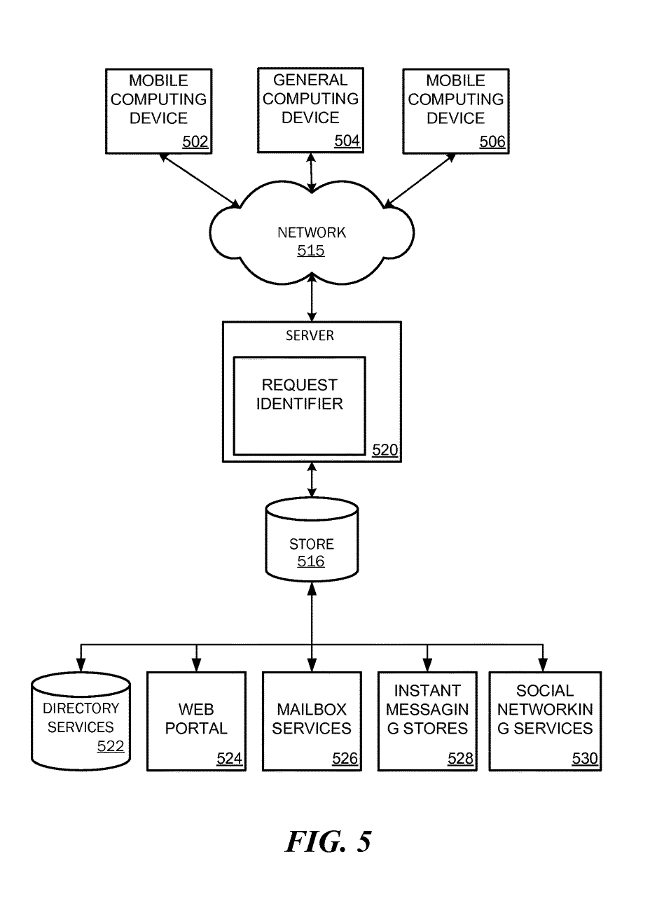

FIG. 5 illustrates another example of the architecture of a system for providing access to multi-output data streams as described above. Data streams accessed, interacted with, or edited in association with the processes and/or instructions to perform the methods disclosed herein may be stored in different communication channels or other storage types. For example, various data may be stored using a directory service 522, a web portal 524, a mailbox service 526, an instant messaging store 528, or a social networking site 530. The processes described herein may use any of these types of systems or the like for enabling data utilization, as described herein. A server 520 may provide a storage system for use by clients and operating on general computing device 504 and mobile device(s) 506 through network 515. By way of example, network 515 may comprise the Internet or any other type of local or wide area network, and the clients may be implemented as a computing device embodied in a personal computing device 318A, a tablet computing device 318B, and/or a mobile computing device 318C and 506 (e.g., a smart phone). Any of these embodiments of the client computing device may obtain content from the store 516.

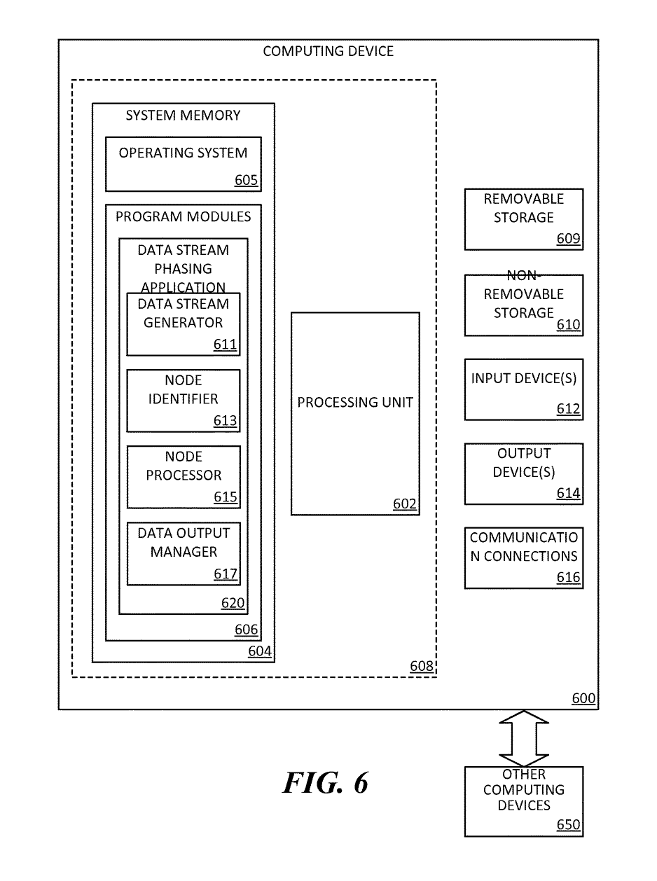

FIG. 6 is a block diagram illustrating physical components (e.g., hardware) of a computing device 600 with which aspects of the disclosure may be practiced. The computing device components described below may have computer executable instructions for phasing a data stream 414 received in response to a multi-output query into a plurality of data sub-streams (e.g., 424, 426, 428, 430, 432 and 434) on a server computing device 320 (or server computing device 520), including computer executable instructions for data stream phasing application 620 that can be executed to employ the methods disclosed herein. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running data stream phasing application 620, such as one or more components in regards to FIG. 6 and, in particular, data stream generator 611, node identifier 613, node processor 615, or data output manager 617. The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., data stream phasing application 620) may perform processes including, but not limited to, the aspects, as described herein. Other program modules that may be used in accordance with aspects of the present disclosure, and in particular may include data stream generator 611, node identifier 613, node processor 615, or data output manager 617, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

This disclosure described some aspects of the present technology with reference to the accompanying drawings, in which only some of the possible embodiments were shown. Other aspects may, however, be embodied in many different forms and should not be construed as limited to the embodiments set forth herein. Rather, these aspects were provided so that this disclosure was thorough and complete and fully conveyed the scope of the possible embodiments to those skilled in the art.

Although specific aspects were described herein, the scope of the technology is not limited to those specific embodiments. One skilled in the art will recognize other embodiments or improvements that are within the scope and spirit of the present technology. Therefore, the specific structure, acts, or media are disclosed only as illustrative embodiments. The scope of the technology is defined by the following claims and any equivalents therein.

What is claimed is:

1. A computer-implemented method comprising:
receiving, by a computing device, a multi-output query;
generating, by the computing device, one or more data streams responsive to the multi-output query;
identifying a plurality of nodes within the one or more data streams, wherein each of the plurality of nodes defines a data sub-stream within the one or more data streams; and
processing at least one of the plurality of nodes to produce a data output responsive to the multi-output query.

2. The method according to claim 1, wherein receiving the multi-output query further comprises receiving a first request to subscribe to at least a first one of the data sub-streams.

3. The method according to claim 1, wherein the multi-output query is automatically received by the computing device based on user preferences learned from user interaction with a local computing device.

4. The method according to claim 2, further comprising:
receiving a second request to subscribe to at least a second one of the data sub-streams, wherein the second one of the data sub-streams shares data output from the one or more data streams;
processing at least one additional node of the plurality of nodes corresponding to the second request to subscribe; and
producing a data output corresponding to the at least one additional node.

5. The computer-implemented method according to claim 1, further comprising receiving a plurality of multi-output queries from a plurality of users, wherein the computing device automatically determines which of the plurality of users is accessing the computing device, and provides a data output corresponding to that user's multi-output query.

6. The computer-implemented method according to claim 1, further comprising receiving a plurality of multi-output queries from a plurality of users, wherein the computing device associates each of the plurality of multi-output queries with one or more of the plurality of users.

7. The method according to claim 1, wherein the multi-output query generates a persistent data output that is stored on at least one server device.

8. The method according to claim 7, wherein at least some of the stored persistent data output is processed after receiving a subsequent query.

9. A system comprising:
at least one processor; and
a memory operatively connected to the at least one processor, the memory comprising computer-executable instructions that, when executed by the at least one processor, perform a method comprising:
receiving a multi-output query;
generating at least one data stream responsive to the multi-output query;
phasing a plurality of data transformation steps for producing a plurality of connectable resources from the at least one data stream;
identifying a plurality of nodes within the plurality of connectable resources, wherein each of the plurality of nodes defines a data sub-stream within the at least one data stream; and
processing at least one of the plurality of nodes to produce a data output responsive to the multi-output query.

10. The system according to claim 9, wherein receiving the multi-output query further comprises receiving a first request to subscribe to at least a first one of the data sub-streams.

11. The system according to claim 9, wherein the multi-output query is automatically received by the computing device based on user preferences learned from user interaction with a local computing device.

12. The system according to claim 10, further comprising:
receiving a second request to subscribe to at least a second one of the data sub-streams, wherein the second one of the data sub-steams shares data output from the at least one data streams;
processing at least one additional node of the plurality of nodes corresponding to the second request to subscribe; and
producing a data output corresponding to the at least one additional node.

13. The system according to claim 9, further comprising receiving a plurality of multi-output queries from a plurality of users, and processing at least one shared node within the plurality of connectable resources to generate a data output responsive to at least one of the plurality of multi-output queries.

14. The system according to claim 9, wherein data output responsive to at least one of a plurality of multi-output queries is persistent data that is stored on at least one server device.

15. The system according to claim 14, wherein at least some of the stored persistent data output is processed after receiving a subsequent query.

16. A computer-readable medium including executable instructions, that when executed on at least one processor, cause the processor to perform operations comprising:
providing a user interface for building a multi-output query;
receiving input to provide the multi-output query;
generating at least one data stream responsive to the multi-output query;
phasing a plurality of data transformation steps for producing a plurality of connectable resources from the at least one data stream;
identifying a plurality of nodes within the plurality of connectable resources, wherein each of the plurality of nodes defines a data sub-stream within the at least one data stream;
processing at least a first one of the plurality of nodes to produce a data output responsive to the multi-output query; and
displaying, through the graphical user interface the data sub-stream responsive to the multi-output query.

17. The computer-readable medium according to claim 16, wherein receiving input to provide the multi-output query further comprises a user inputting into the user interface a first request to subscribe to at least a first one of the data sub-streams.

18. The computer-readable medium according to claim 16, wherein receiving input to provide the multi-output query is at least partially automatically received based on learned user preferences.

19. The computer-readable medium according to claim 16, further comprising graphically displaying, by the user interface, the plurality of connectable resources and the plurality of nodes.

20. The computer-readable medium according to claim 16, further comprising:
filtering the at least one data stream from a data provider; and
splitting the at least one data stream into a plurality of data sub-streams.
